(19) United States
(12) Patent Application Publication
(10) Pub. No.: US 2022/0163407 A1
(43) Pub. Date: May 26, 2022

(54) Thermally Isolated Temperature Sensor in a Toilet Bowl

(71) Applicant: Medic, Inc., Provo, UT (US)

(72) Inventors: David R. Hall, Provo, UT (US); Joshua Larsen, Spanish Fork, UT (US); John W. Christiansen, American Fork, UT (US)

(21) Appl. No.: 17/535,426

(22) Filed: Nov. 24, 2021

Related U.S. Application Data
(60) Provisional application No. 63/117,624, filed on Nov. 24, 2020.

(51) Int. Cl. G01K 13/02; G01K 1/14; E03D 11/13

(52) U.S. Cl. CPC G01K 13/026; E03D 11/13; G01K 1/14

(57) ABSTRACT

A urine temperature measuring apparatus comprising a receptacle adapted to fit into a front area of a toilet bowl for receiving urine; a channel positioned below the receptacle such that urine in the receptacle may flow into the channel; a temperature sensor in the channel; and an outlet from the channel draining into the toilet bowl is disclosed. An analytical toilet comprising a bowl adapted to receive excreta; a receptacle in a front area of a toilet bowl for receiving urine; a channel positioned below the receptacle such that urine in the receptacle may flow into the channel; a temperature sensor in the channel; and an outlet from the channel draining into the toilet bowl is also disclosed. A method of measuring body temperature using a toilet including the step of providing a receptacle adapted for placement in the front of a toilet bowl to receive urine. The receptacle includes a channel positioned below the receptacle such that urine in the receptacle may flow into the channel; a temperature sensor in the channel; and an outlet from the channel draining into the toilet bowl is also disclosed. The method further includes the steps of depositing urine in the toilet bowl so as to flow into the channel and sensing the temperature of the urine by the temperature sensor.

### CROSS-REFERENCE TO RELATED APPLICATIONS

This application claims the benefit under 35 U.S.C. 119(e) of U.S. Provisional Patent Application No. 63/117,624 titled “Thermally Isolated Temperature Sensor in a Ceramic Toilet Bowl” filed on 24 Nov. 2020, which disclosure is incorporated herein by reference in its entirety.

### TECHNICAL FIELD

The present disclosure relates to analytical toilets. More particularly, it relates to analytical toilets equipped to provide health and wellness information to the user.

### BACKGROUND

The ability to track an individual's health and wellness is currently limited due to the lack of available data related to personal health. Many diagnostic tools are based on examination and testing of excreta, but the high cost of frequent doctor's visits and/or scans make these options available only on a very limited and infrequent basis. Thus, they are not widely available to people interested in tracking their own personal wellbeing.

Toilets present a fertile environment for locating a variety of useful sensors to detect, analyze, and track trends for multiple health conditions. Locating sensors in such a location allows for passive observation and tracking on a regular basis of daily visits without the necessity of visiting a medical clinic for collection of samples and data. Monitoring trends over time of health conditions supports continual wellness monitoring and maintenance rather than waiting for symptoms to appear and become severe enough to motivate a person to seek care. At that point, preventative care may be eliminated as an option leaving only more intrusive and potentially less effective curative treatments. An ounce of prevention is worth a pound of cure.

There are many challenges involved with measuring a person's core body temperature while they are using the restroom. There are privacy concerns as well as making sure the measurement is accurate enough to be useful. It is possible to place a temperature sensor where it will contact the user's skin (e.g., in the seat to contact user's thing) but this does not yield an accurate and reliable measurement of core temperature. Infrared cameras may be used to measure excreta as it leaves a user's body, but this requires the use of an expensive camera that may also raise privacy concerns for users. Thermal sensors place on or in the bowl may be used to measure the temperature of urine. However, the ceramic material used to make the bowl has a high thermal conductivity and cools the urine quickly. It is also impossible to control where urine will impact the bowl making it impossible to control or predict how urine temperature will be affected prior to interacting with a temperature sensor.

Just a few examples of smart toilets and other bathroom devices can be seen in the following U.S. Patents and Published Applications: U.S. Pat. No. 9,867,513 entitled “Medical Toilet With User Authentication”; U.S. Pat. No. 10,123,784 entitled “In Situ Specimen Collection Receptacle In A Toilet And Being In Communication With A Spectral Analyzer”; U.S. Pat. No. 10,273,674 entitled “Toilet Bowl For Separating Fecal Matter And Urine For Collection And Analysis”; US 2016/0000378 entitled “Human Health Property Monitoring System”; US 2018/0020984 entitled “Method Of Monitoring Health While Using A Toilet”; US 2018/0055488 entitled “Toilet Volatile Organic Compound Analysis System For Urine”; US 2018/0078191 entitled “Medical Toilet For Collecting And Analyzing Multiple Metrics”; US 2018/0140284 entitled “Medical Toilet With User Customized Health Metric Validation System”; and US 2018/0165417 entitled “Bathroom Telemedicine Station.” The disclosures of all these patents and applications are incorporated by reference in their entireties.

### SUMMARY

In a first aspect, the disclosure provides a urine temperature measuring apparatus comprising a receptacle adapted to fit into a front area of a toilet bowl for receiving urine; a channel positioned below the receptacle such that urine in the receptacle may flow into the channel; a temperature sensor in the channel; and an outlet from the channel draining into the toilet bowl.

In a second aspect, the disclosure provides an analytical toilet comprising a bowl adapted to receive excreta; a receptacle in a front area of a toilet bowl for receiving urine; a channel positioned below the receptacle such that urine in the receptacle may flow into the channel; a temperature sensor in the channel; and an outlet from the channel draining into the toilet bowl.

In a third aspect, the disclosure provides a method of measuring body temperature using a toilet including the step of providing a receptacle adapted for placement in the front of a toilet bowl to receive urine. This receptacle includes a channel positioned below the receptacle such that urine in the receptacle may flow into the channel; a temperature sensor in the channel; and an outlet from the channel draining into the toilet bowl. The method further includes the steps of depositing urine in the toilet bowl so as to flow into the channel and sensing the temperature of the urine by the temperature sensor.

Further aspects and embodiments are provided in the foregoing drawings, detailed description, and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is an isometric view of a first exemplary embodiment of a toilet bowl and insert according to the present disclosure.

FIG. 2 is a side cross-sectional view of the embodiments of FIG. 1.

FIG. 3 is an isometric view of a second exemplary embodiment of a toilet bowl and insert according to the present disclosure.

FIG. 4 is an isometric view of a third exemplary embodiment of a toilet bowl and insert according to the present disclosure.

FIG. 5 is an isometric view of an exemplary embodiment of a urine channel or slit according to the present disclosure.

FIG. 6 is another isometric view of the embodiment of FIG. 5.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “toilet” is meant to refer to any device or system for receiving human excreta, including urinals.

As used herein, the term “bowl” refers to the portion of a toilet that is designed to receive excreta.

As used herein, the term “base” or “frame” refers to the portion of the toilet below and around the bowl supporting it.

As used herein, the term “user” refers to any individual who interacts with the toilet and deposits excreta therein.

As used herein, the term “excreta” refers to any substance released from the body of a user including urine, feces, menstrual discharge, saliva, expectorate, and anything contained or excreted therewith.

As used herein, the term “sensor” is meant to refer to any device for detecting and/or measuring a property of a person or of a substance regardless of how that property is detected or measured, including the absence of a target molecule or characteristic. Sensors may use a variety of technologies including, but not limited to, transducers, MOS (metal oxide semiconductor), CMOS (complementary metal oxide semiconductor), CCD (charge-coupled device), FET (field-effect transistors), nano-FET, MOSFET (metal oxide semiconductor field-effect transistors), spectrometers, volume measurement devices, weight sensors, temperature gauges, chromatographs, mass spectrometers, IR (infrared) detector, near IR detector, visible light detectors, and electrodes, microphones, load cells, pressure gauges, PPG (photoplethysmogram), thermometers (including IR and thermocouples), rheometers, durometers, pH detectors, scent detectors gas, and analyzers.

As used herein, the term “data connection” and similar terms are meant to refer to any wired or wireless means of transmitting analog or digital data and a data connection may refer to a connection within a toilet system or with devices outside the toilet.

### Exemplary Embodiments

The present disclosure relates to methods and apparatus for measuring core body temperature by measuring excreta temperature in a toilet. The disclosed system utilizes a thermally isolated urine collection receptacle that directs urine into a small channel with a temperature sensor. The system preferably uses a sensor that reacts to temperature changes quickly so that core body temperature can be measured before the urine sample cools.

In some embodiments, the system is inserted into the bowl via openings in the bowl. In preferred embodiments, in addition to providing mounting points, the opening provides conduits for electrical power, data, and/or fluids. The insert is designed to prevent urine that comes into contact with the bowl from entering the channel.

In a preferred embodiment, the insert includes an exit for urine and cleaning fluid into the bowl for elimination via flushing. In various exemplary embodiments, the system is located near the front of the toilet (from the perspective of a seated user) to collect urine from a seated or standing user. In alternative embodiments, the insert is attached to the bowl using adhesive without any openings into the bowl material. In some embodiments, the data connection to the temperature sensor is a wireless connection (e.g., Wi-Fi or Bluetooth®).

In various exemplary embodiments, the insert prevents enough heat transfer from the urine to the insert and to the bowl to enable the collection of an accurate temperature reading very quickly after urine enter the device. In various exemplary embodiments, the insert comprises side walls that separate the interior of the device from the bowl such that urine in the bowl does not enter the device. In various exemplary embodiments, the device is located under the rim so that flush water from the toilet with enter and clean out the device after each use. In a preferred embodiment, the channel includes multiple temperature sensors to increase the amount and accuracy of data measurements.

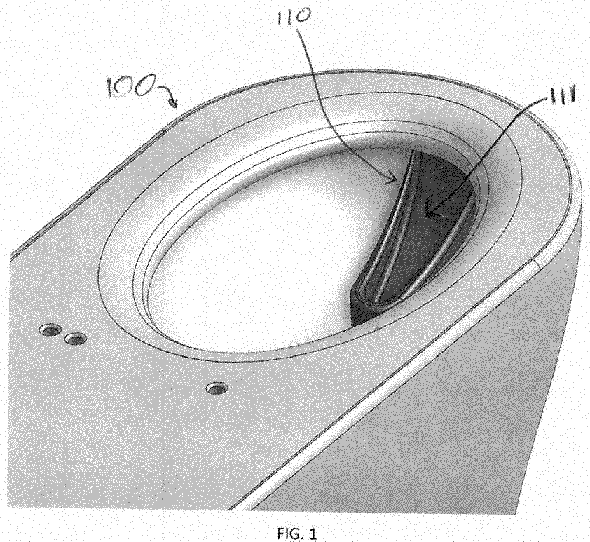

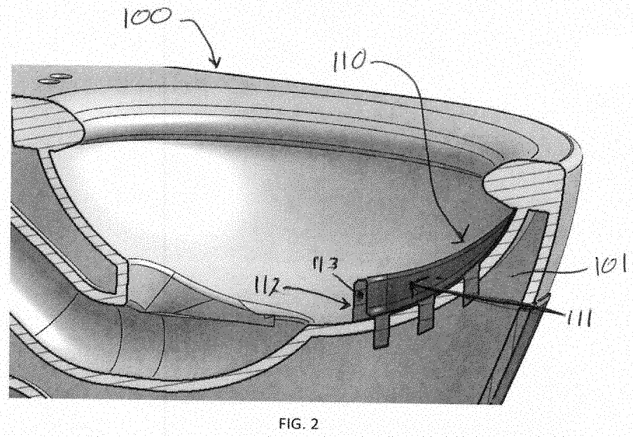

Now referring to FIGS. 1 and 2, a preferred embodiment comprises an insert 110 that is added to a conventional toilet 100 is shown. Urine in the insert 110 flows from a receptacle area 111 into a channel or slit 112 and then into the toilet bowl. One or more temperature sensors 113 in the channel 112 measure urine temperature and transmit this data to a controller. The channel design allows urine to collect in the receptacle and insures that the channel will be filled which provides for more predictable flow through the channel and more accurate and reliable temperature measurements.

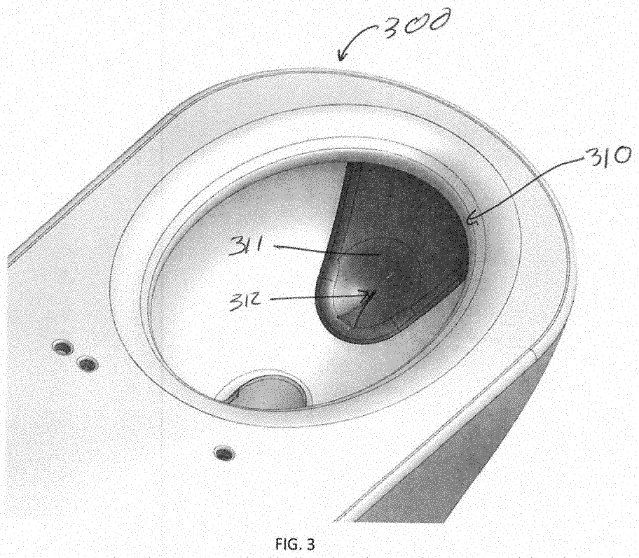

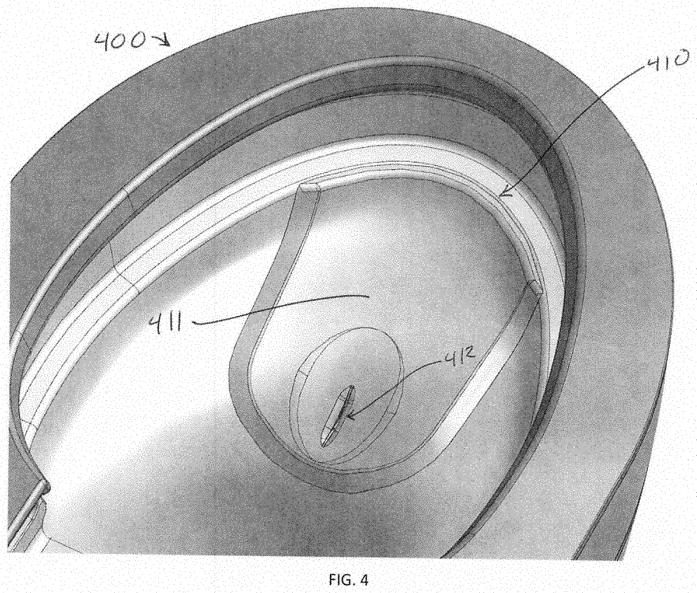

Now referring to FIG. 2, in a preferred embodiment, the insert 110 is attached to the bowl 100 via holes 101 in the bowl surface. The holes also preferably provide electrical, data, and/or fluid connections to the insert. These connections may power the temperature sensor, transmit data from the temperature sensor, pull urine samples from the receptacle or channel, and/or provide cleaning fluid to the device. An alternative embodiment may be built into a toilet bowl replacing a section of conventional bowl wall (see FIGS. 3 and 4).

In preferred embodiments, there is a space 101 between the bowl and the outer surface of the toilet for electrical or fluid connections (not shown) to the device. This space could also contain other components such as, but not limited to, processors, memory, batteries, and wireless transmitters.

Now referring to FIG. 3, another exemplary embodiment of a thermally isolated urine testing device 310 in a toilet 300 is shown. The device 310 is designed to allow urine to flow from the receptable area 311 over at least one thermocouple 313 before exiting the channel 312. In preferred embodiments, urine is not allowed to pool in the channel 312 such that the urine in contact with the temperature sensors is flowing and does not pool there even briefly.

Now referring to FIG. 4, a third exemplary embodiment of a thermally isolated urine testing 410 in a toilet bowl 400 device is shown. This device is shaped differently from the embodiment of FIG. 3 in order to fit into a different shaped bowl 400. The device is designed to allow urine to flow from the receptacle 411 over at least one thermocouple 413 before exiting the channel 412. In preferred embodiments, urine is not allowed to pool in the channel 412 such that the urine in contact with the temperature sensors is flowing and does not pool there even briefly.

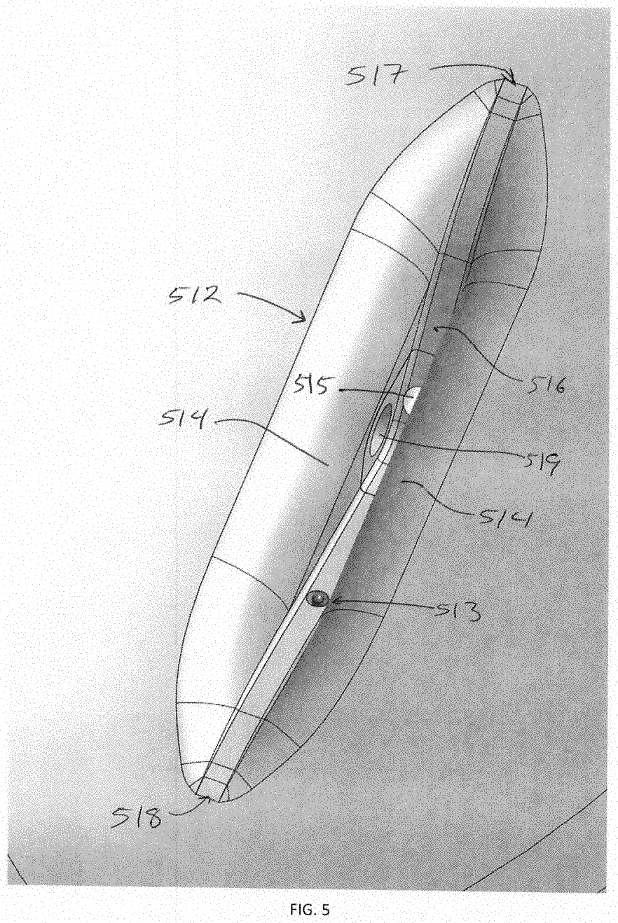

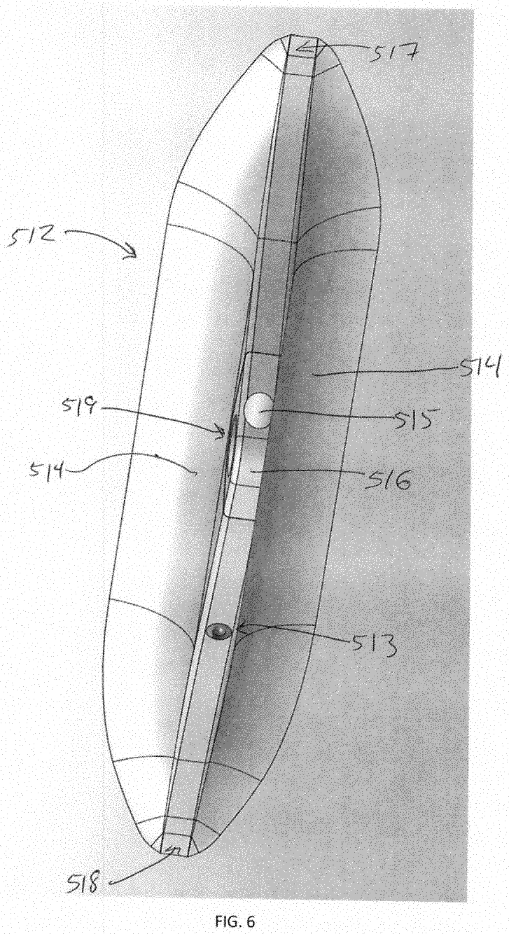

Now referring to FIGS. 5 and 6, an exemplary embodiment of a channel or slit 512 adapted for use with the embodiments of FIGS. 3 and 4 is shown. The channel comprises two sidewalls 514 and a bottom or back 516. Urine flows into a top end 517 of the channel, through the channel 511, and out a bottom end 518 of the channel to the bottom of the device and into the bowl. One or more temperature sensors 513, such as a thermocouple, may be placed in the sidewalls and/or bottom of the channel 511 to measure urine temperature. In some embodiments, flush fluid may be injected into the channel 510 through opening 515. In various exemplary embodiments, the channel may be formed by a depression or cavity in the insert or by raising the sidewalls above the level of the surrounding insert.

In various exemplary embodiments, the channel includes two fiber optic light transmitters 519 in the sidewalls. This provides for use of spectrometry to analyze urine. By passing light (of any visible or nonvisible wavelengths) through the urine sample, it is possible to identify and quantify a wide variety of analytes in the urine, which data may provide important insights into the health and wellness of the toilet user.

In an alternative embodiment, the bottom of the channel comprises a valve and drain to receive urine to be transported elsewhere in the system, which may be internal or external to the toilet, for further testing such as that described below.

In various exemplary embodiments, the channel includes a drain that allows captured urine to exit the channel into the bowl without bowl liquids entering the channel. In some embodiments, the drain is controlled by a valve. The valve may be a passive one-way valve that prevents flow into the channel from the bowl or may be a valve that is opened after temperature data is acquired. In preferred embodiments, the channel is sized and positioned to be above the level of standing water in the toilet. In preferred embodiments, urine flows through the channel and then to the bottom edge of the device where it flows into the toilet. In alternative embodiments, the urine drains through the back of the channel into the bowl or through the side of bowl for additional testing rather than immediate disposal.

In various exemplary embodiments, the toilet may include other sensors in the channel, bowl, toilet seat or lid, and elsewhere to measure other characteristics of the user directly or in their excreta. These sensors may detect use cardiovascular data, such as but not limited to, pulse, blood pressure, and blood oxygenation. The sensors may also detect excreta characteristics, including but not limited to, content, volume, specific gravity, and flow rates.

In various exemplary embodiments, the bowl may be made from ceramic, glass, or a polymer material.

In various exemplary embodiments, the system is designed to be part of a urinal. In such an embodiment, the receptacle is designed to divert flow from above it around the receptacle to the drain rather than allowing it to flow into the receptacle. Special plumbing or connections may be necessary to provide flush water into the receptacle depending on the type of urinal.

All patents, published patent applications, and other publications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A urine temperature measuring apparatus comprising:
a receptacle adapted to fit into a front area of a toilet bowl for receiving urine;
a channel positioned below the receptacle such that urine in the receptacle may flow into the channel;
a temperature sensor in the channel; and
an outlet from the channel draining into the toilet bowl.

2. The apparatus of claim 1 wherein the channel is positioned to receive flush water when the toilet is flushed.

3. The apparatus of claim 3 wherein the drain comprises a one-way valve.

4. The apparatus of claim 1 wherein the apparatus is designed to be added to a conventional toilet.

5. The apparatus of claim 1 further comprising a wireless data transmitter.

6. The apparatus of claim 1 wherein the temperature sensor comprises a plurality of temperature sensors.

7. The apparatus of claim 1 wherein the channel comprises a back and two sidewalls.

8. The apparatus of claim 1 wherein the channel comprises an outlet on a back side of the apparatus.

9. The apparatus of claim 1 wherein the channel further comprises two fiber optic cables disposed through opposite sides of the channel.

10. An analytical toilet comprising:
a bowl adapted to receive excreta;
a receptacle in a front area of a toilet bowl for receiving urine;
a channel positioned below the receptacle such that urine in the receptacle may flow into the channel;
a temperature sensor in the channel; and
an outlet from the channel draining into the toilet bowl.

11. The analytical toilet of claim 10 wherein the channel is positioned to receive flush water when the toilet is flushed.

12. The analytical toilet of claim 10 wherein the drain comprises a one-way valve.

13. The analytical toilet of claim 10 further comprising a wireless data transmitter.

14. The analytical toilet of claim 10 wherein the temperature sensor comprises a plurality of temperature sensors.

15. The analytical toilet of claim 10 wherein the channel comprises a back and two sidewalls.

16. The analytical toilet of claim 10 herein the channel comprises an outlet on a back side of the apparatus.

17. The analytical toilet of claim 10 wherein the channel further comprises two fiber optic cables disposed through opposite sides of the channel.

18. A method of measuring body temperature using a toilet comprising:
providing a receptacle adapted for placement in the front of a toilet bowl to receive urine, comprising:
a channel positioned below the receptacle such that urine in the receptacle may flow into the channel;
a temperature sensor in the channel; and
an outlet from the channel draining into the toilet bowl;
depositing urine in the toilet bowl so as to flow into the channel; and
sensing the temperature of the urine by the temperature sensor.

19. The method of claim 18 wherein the channel further comprises a back and sidewalls.

20. The method of claim 18 wherein the channel further comprises two fiber optic cables disposed through opposite sides of the channel.
